(19) United States
(12) Patent Application Publication
(10) Pub. No.: US 2005/0020113 A1
(43) Pub. Date: Jan. 27, 2005

(54) Child-resistant plug protector

(75) Inventors: Scott A. Melton, Erie, IL (US); Keith W. Dirks, Sterling, IL (US)

Correspondence Address: GREER, BURNS & CRAIN, 300 S WACKER DR, 25TH FLOOR, CHICAGO, IL, 60606, US

(73) Assignee: WAHL CLIPPER CORPORATION

(21) Appl. No.: 10/624,030

(22) Filed: Jul. 21, 2003

(51) Int. Cl. H01R 13/44

(52) U.S. Cl. 439/149

(57) ABSTRACT

An electrical plug protector for use on an electrical plug with a cord having an enclosure portion with members moveable between an open position and a closed position and a cord tethering portion associated with the enclosure portion for attaching the enclosure portion to the cord.

### BACKGROUND OF THE INVENTION

This invention relates generally to devices for preventing unauthorized use of electrical appliances, and more particularly to an electrical plug protector.

Various electrical plug lockout devices are available and typically involve an industrial application and are meant to prevent unauthorized or accidental use of hazardous electrical equipment. Such devices are designed to prevent adult access to the plug by use of a lock, which requires a tool such as a key to disengage.

A concern by many households is the concept of children obtaining unauthorized access to electrical appliances or other equipment that might become hazardous. One approach to this problem is the use of electrical socket fillers or protectors. A disadvantage of this technique is that in some cases several electrical sockets in a residence are sometimes left exposed for use. The advantage of using electrical plug lockout devices is that the adult may restrict children from using an electrical device that is a hazard concern, independent of any protection of the outlets.

One challenge of using conventional plug lockout devices for home applications is that the device generally requires a user to locate a key before enabling the plug. In addition, conventional plug lockout devices are typically bulky and difficult to manage. Furthermore, many plug lockout devices must be completely removed from the cord or plug to gain access to the plug, often resulting in misplacement of the lockout device. Parents or guardians with young children often have specific electrical appliances such as hair clippers and curling irons that cause them a heightened sense of concern due to their potential hazardous condition when handled or used by children.

Thus, there is a need for a plug protector capable of keeping children from obtaining unauthorized access to an electrical plug, yet which allows an adult easy access to the plug when desired. In addition, there is a need for such a device that makes such use convenient.

### BRIEF SUMMARY OF THE INVENTION

The above-identified needs are addressed by the present child-resistant electrical plug protector, which is attachable to a conventional electrical plug and cord. One feature of the present invention is an enclosure portion which includes hinged members that are moveable between an open position and a closed position. A latch holds the members closed and is strong enough to resist opening by children. The latch, however, is configured to allow an adult user to open the enclosure without the use of a tool or key. Another optional feature of the enclosure portion is that it is tapered to conform to the overall shape of the plug to minimize the amount of space consumed by the plug protector. Still another feature of the present plug protector is a cord tethering portion used for attaching the enclosure portion to the cord, enabling the user to keep the plug protector attached to the electrical cord when the plug is being utilized.

More specifically, an electrical plug protector is provided that includes an enclosure portion with members moveable between an open position and a closed position and a cord tethering portion associated with the enclosure portion for attaching the enclosure portion to the cord. In another embodiment, an electrical plug protector for use on an electrical plug with a cord includes an enclosure portion with at least two members each defined by a top portion, side portions, and a base moveable between an open position and a closed position. A cord tethering portion is associated with the enclosure portion, and a hinge mechanism connects the members to each other. In the preferred embodiment, the hinge mechanism of the electrical plug protector is located on the base of the plug protector, or alternatively, on one of the side portions of the plug protector.

In an additional embodiment, an electrical plug protector for use on an electrical plug with a cord includes an enclosure portion with members moveable between an open position and a closed position. The enclosure portion includes at least two members each defined by a top portion, side portions, and a base. Preferably, the members are latchable to each other. Also, the enclosure is configured to taper on side portions towards the cord tethering portion to conform to the overall shape of the plug. A cord tethering portion is associated with the enclosure portion, and a clasp is located at the tethering portion for detachably engaging the cord.

### BRIEF DESCRIPTION OF THE DRAWINGS

FIG. 1 is a top perspective view of an electrical plug protector attached to a plug in the open position;

FIG. 2 is a top perspective view of the electric plug protector shown in FIG. 1 with the plug removed;

FIG. 3 is a top perspective view of the electric plug protector shown in FIG. 1 in the closed position;

FIG. 4 is a top perspective view of an alternate embodiment of the plug protector of FIG. 1;

FIG. 5 is a top perspective view of a second alternate embodiment of the plug protector of FIG. 1; and

FIG. 6 is a top perspective view of a third alternate embodiment of the plug protector of FIG. 1.

### DETAILED DESCRIPTION OF THE INVENTION

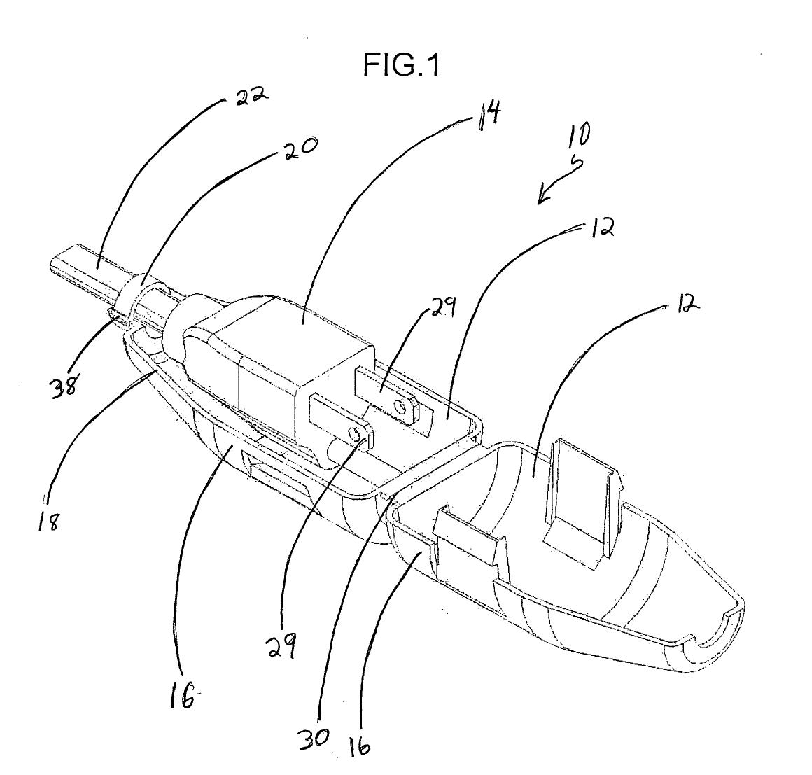

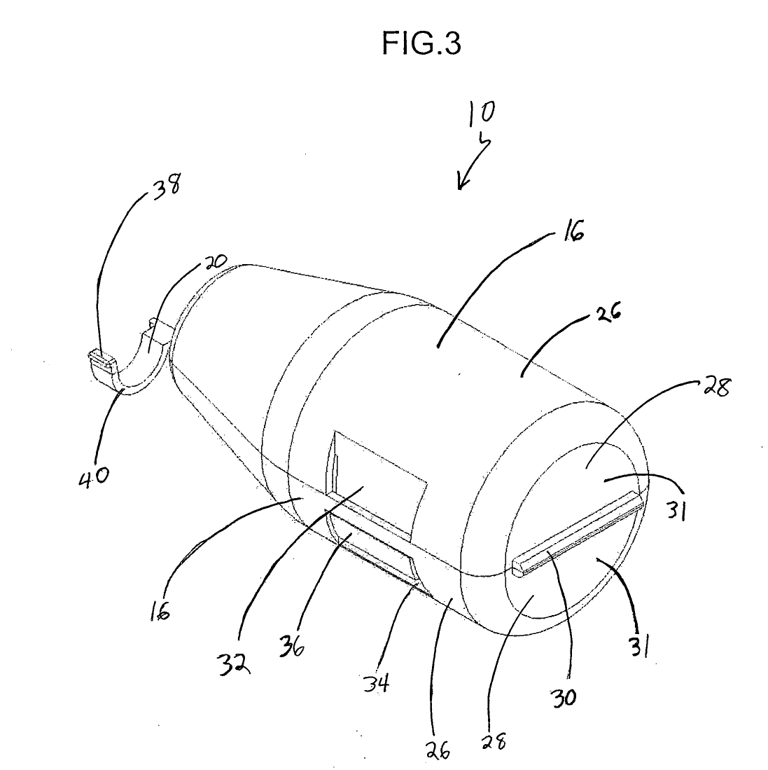

Referring now to FIG. 1, an electrical plug protector for use on an electrical plug with a cord is generally designated 10. Included on the plug protector 10 is an enclosure 12 enclosing a plug 14 used to power an appliance (not shown) as is known in the art. While a three prong plug 14 is depicted, it is contemplated that the present plug protector 10 is usable on other conventional plugs, including, but not limited to two prong plugs and foreign plugs. The enclosure 12 includes at least two members 16 that are moveable between an open position (FIG. 1) and a closed position (FIG. 3). While two members 16 are preferred, it is also contemplated that the enclosure 12 may include a larger number of members 16. At least one member 16 preferably has a solid outer wall 18. However, walls having openings are also contemplated. Also included on the plug protector 10 is a cord tethering portion 20 associated with the enclosure 12 for attaching the enclosure 12 portion to a cord 22. As is well known, the cord 22 is connected to the plug 14.

For facilitating use of the electrical plug protector 10, and for addressing some of the above-identified needs, the enclosure 12 is preferably configured to closely conform to the overall shape of the plug 14. The side portions 26 are configured to encapsulate the plug 14 and preferably have a generally cylindrical or barrel shape conforming to the shape of the plug 14. However, it is also contemplated that other existing shapes are also suitable that encapsulate the plug, depending on the application. Preferably, the enclosure 12 is configured to taper on the side portions 26 towards the cord tethering portion 20 to generally conform to an overall shape of the plug 14.

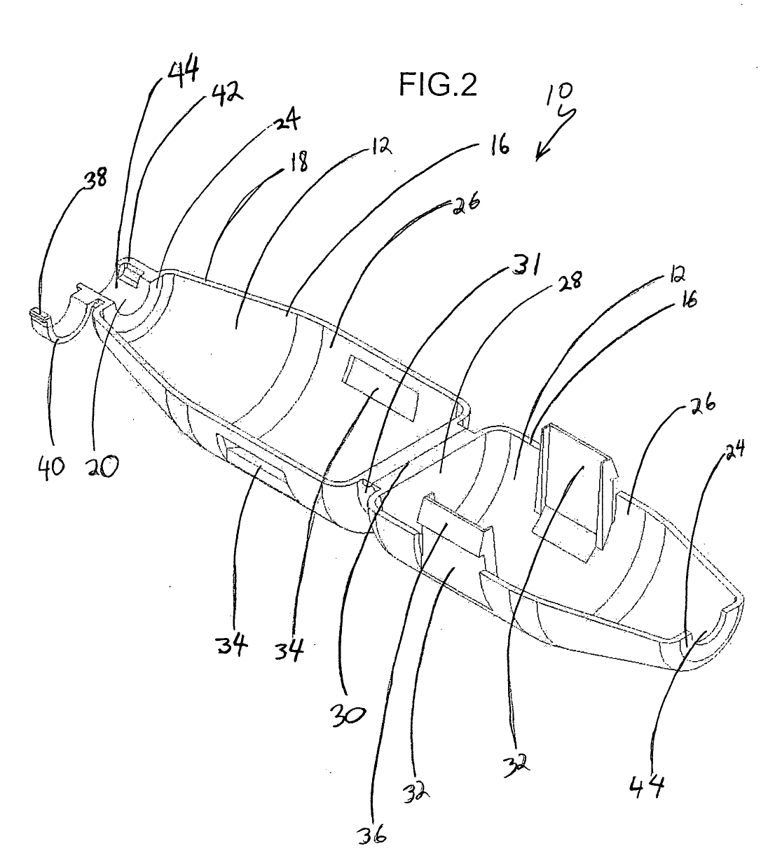

More specifically, and referring to FIG. 2, the enclosure 12 includes a top portion 24, side portions 26 and a base 28. The top portion 24 refers to the part of the enclosure adjacent to the cord tethering portion and connects the cord tethering portion 20 to the side portions 26. When in the closed position, the top portion 24 prevents the plug 14 from sliding out of the plug protector 10 by having a diameter large enough to encompass the cord 22, yet small enough to prevent the plug 14 from falling through.

Opposite the top portion, the base 28 refers to the lower portion of the enclosure 12 adjacent to the prongs 29 of the plug 14. The base 28 is configured to seal the side portions 26 on the opposing end of the top portion 20 and prevent the plug 14 from sliding down the cord 22 when closed.

Referring again to FIG. 1, it is preferred that the plug 14 fits securely in enclosure 12 to minimize the size of the overall plug protector 10. Thus, the plug protector 10 has a relatively smaller volume than conventional industrial-type plug protectors.

Referring now to FIGS. 1-3, the enclosure 12 is configured to make the plug 14 accessible when in the open position. In the preferred embodiment, upon opening, the plug 14 becomes exposed for use. It is preferred that the members 16 are connected to each other by at least one hinge 30 so that the members 16 remain connected to each other while in the open position. In this manner, the plug protector 10 remains intact so that the possible loss of multiple members 16 is avoided. While a one-price integral “living hinge” is depicted, it is contemplated that multi-piece, assembled hinges of various known configurations are also suitable.

Referring to FIG. 2, at least one hinge 30 is located at the base 28 of the plug protector 10, and preferably in the mid-section of the base 28. In this location, the enclosure 12 is configured such that outer base walls 31 of each member 16 face each other in the open position.

Referring now to FIGS. 1-3, it is preferred that the members 16 are releasably latchable to each other. Accordingly, the members 16 include at least one latch 32 forming a male connection piece on one of the members 16 and configured to be latchable to a corresponding female formation (a slot or opening) 34 located on a second of the members 16. While two latches 32 are shown, the number may vary (increase or decrease) depending on the application. To facilitate securing the members 16 in the closed position, the latch 32 has a barb 36.

Referring now to FIG. 3, it will be seen that the latch 32 secures the members 16 together in the closed position. The latch 32 is configured so that when in the closed position, the enclosure 12 is openable without the use of tools. Thus, the precise construction and arrangement of the latch 32 and the female formation 34 may vary to suit the application. Furthermore, it is preferred that the barb 36 requires an opening squeeze force sufficient to prevent children from disengaging the male connection piece 32 from the female formation 34, yet allows disengagement by adults. It will be seen that an important advantage of this embodiment is that the plug protector 10 allows the user to access the plug 14 without the use of a or other tools key while being able to prevent young children from accessing the plug when desired.

Referring now to FIG. 1, the cord tethering portion 20 is provided with a clasp 38 configured for detachably and slidably engaging the cord 22. The tethering portion 20 is configured for attaching to the cord 22 independent of the members 16 being in an open or closed position. This configuration allows the plug protector 10 to remain on the cord 22 when the plug 14 is engaged to prevent possible loss of the plug protector 10. The cord tethering portion 20 preferably includes at least one securing member 40 hingedly connected to a fixed member 42. This configuration enables the user to detach or attach the plug protector 10 from the cord 22 so that the plug protector 10 is usable with multiple plug applications. It is also preferred that, as is the case with the latch 32, the clasp 38 is configured to require a sufficient opening squeeze force to prevent actuation by young children. In this embodiment, children will preferably be unable to detach the plug protector 10 from the cord 22 to prevent a possible loss of the plug protector 10, yet ensure that adults will be capable of removing the plug protector 10 without the use of a tool. When closed, the securing member 40 and the fixed member 42 combine to define a generally circular opening 44 dimensioned to encircle and slidingly engage the cord 2. This opening 44 is in communication with the interior of the solid outer wall 18, and may be partially defined by both members 16.

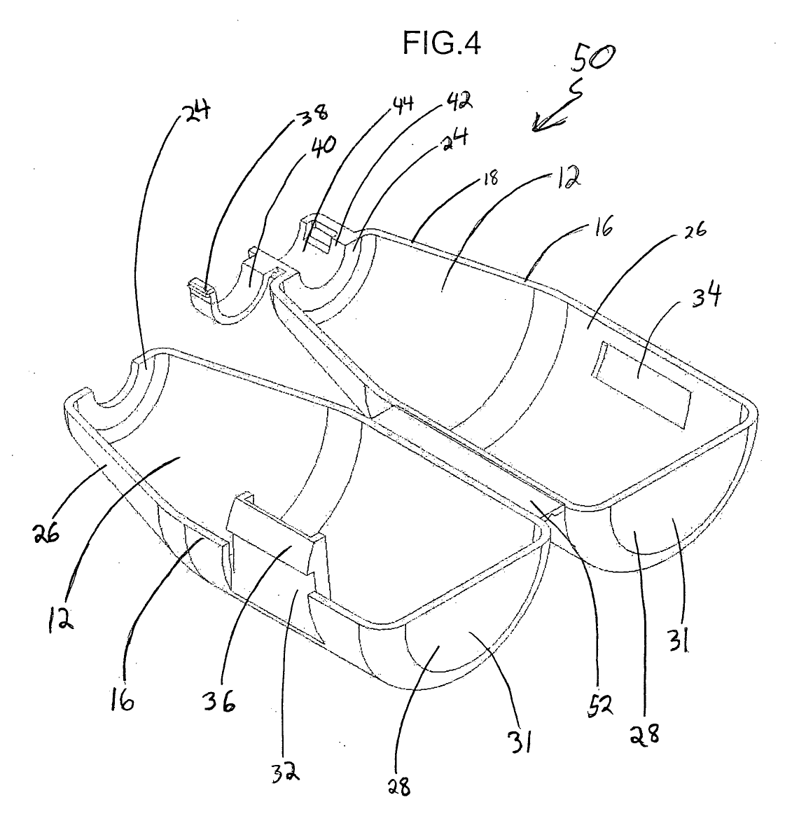

Referring now to FIG. 4, an alternate embodiment of the protector 10 is generally designated 50. Components shared with the protector 10 have been designated with the same reference numbers. A main difference between the protectors 10 and 50 is that at least one hinge 52 is located along adjacent side portions 26 of the plug protector 10. In this location, the enclosure 12 is configured such that when in the open position the members 16 of side portions 26 lie generally parallel to each other. Another distinguishing feature of the protector 50 is that only one latch 32 and one female formation 34 are provided.

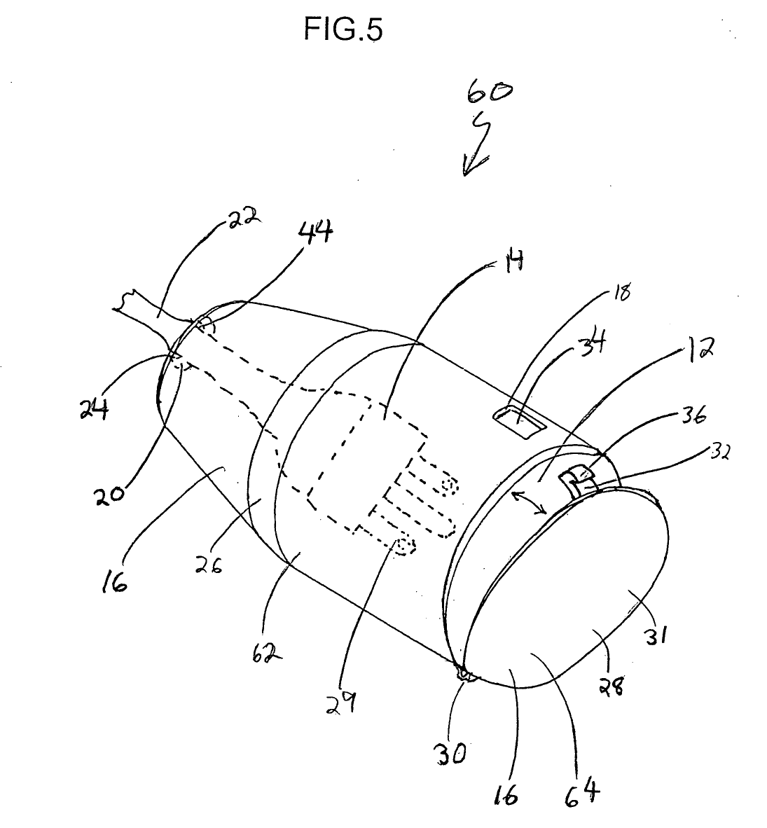

Referring now to FIG. 5, another alternate embodiment is generally designated 60. Components shared with the embodiments 10 and 50 have been designated with the same reference numbers. A main distinguishing feature of the protector 60 is that at least one enclosure member 62 circumscribes the plug 14 and another member 64 is configured as a door which is hingable and latchable to the member 62. Since the member 62 fully encircles the plug 14, it is contemplated that the cord 22 is passed through the opening 44 prior to assembly with the appliance. Alternatively, the enclosure member 62 may be provided in two pieces as in FIG. 1 which are secured to each other around the plug 14, either permanently or temporarily. Once assembled (as shown), the plug 14 is engagable by opening the latch 32 and sliding the protector 60 back along the cord 22.

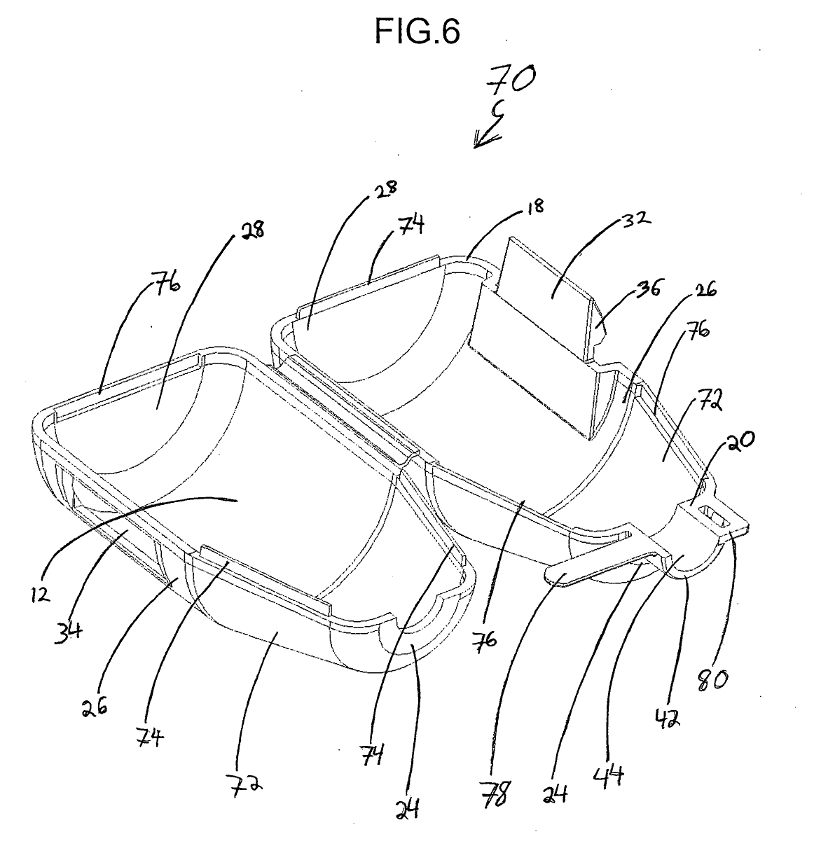

Referring now to FIG. 6, another alternate embodiment is generally designated 70. Components shared with the protector 10, 50, and 60 have been designated with the same reference numbers. A main distinguishing feature of the protector 70 is that the enclosure members 72 have at least one tab 74 and a corresponding recess 76 to provide the members 72 with additional structural strength when in the closed position. The preferred embodiment incorporates three tabs 74 and three recesses 76 that are spaced apart along the side portions 26 and base 28 so that when the protector 70 is closed, additional structural support is given. A second distinguishing feature of the protector 70 is that a strap 78 is utilized at the cord tethering portion 20 to secure the protector 70 to the cord 22 by fastening the strap 78 around the cord 22 through a buckle 80. It is preferred that the strap 78 and the buckle 80 are located on opposing ends of the opening 44.

Thus, it will be seen that the present plug protector 10, 50, 60, 70 facilitates the use of protecting children from dangerous electrical appliances. The plug 10 is completely enclosed with the use of a latch 32 to prevent unauthorized use by children. Furthermore, the enclosure 12 is openable without the use of a tool, eliminating the inconvenience of keeping track of an additional key. The small size of the plug protector reduces the space taken up by bulkier-industrial sized lockout protectors. Moreover, the clasp 38 allows the user to remove the device and install it on other electrical plugs.

While a particular embodiment of the present electrical plug protector has been described herein, it will be appreciated by those skilled in the art that changes and modifications may be made thereto without departing from the invention in its broader aspects and as set forth in the following claims.

1. An electrical plug protector for use on an electrical plug with a cord, comprising:
an enclosure portion with members moveable between an open position and a closed position;
an external cord tethering portion for detachably engaging the cord, associated with at least one of said members and configured for substantially encircling the cord; and
when in said closed position, said enclosure portion completely encloses said plug for preventing unwanted engagement of the plug with a socket and is configured to be openable without the use of tools.

2. The electrical plug protector of claim 1 wherein said enclosure portion includes at least two of said members.

3. The electrical plug protector of claim 1 wherein said open position is configured to make the plug accessible.

4. The electrical plug protector of claim 1 wherein said cord tethering portion is provided with a clasp configured for detachably encircling the cord.

5. (Cancelled)

6. The electrical plug protector of claim 2 wherein said members are latchable to each other.

7. The electrical plug protector of claim 2 wherein said electrical plug protector includes a top portion, side portions, and a base.

8. The electrical plug protector of claim 7 wherein said enclosure is configured to taper on said side portions towards said cord tethering portion to conform to an overall shape of the plug.

9. The electrical plug protector of claim 1 wherein said tethering portion is configured to move slidably along the cord independent of said members being in said open or said closed position.

10. The electrical plug protector of claim 2 wherein at least one member has a solid outer wall.

11. The electrical plug protector of claim 6 further including at least one latch forming a male connection piece on one of said members and configured to be latchable to a corresponding female formation located on a second of said members.

12. The electrical plug protector of claim 7 wherein said members are connected to each other by at least one hinge.

13. The electrical plug protector of claim 12 wherein said at least one hinge is located at said base of said plug protector.

14. The electrical plug protector of claim 12 wherein said at least one hinge is located at one of said side portions of said plug protector.

15. (Canceled)

16. (Canceled)

17. The electrical plug protector of claim 4 wherein said cord tethering portion includes at least one securing member hingedly connected to a fixed member.

18. An electrical plug protector for use on an electrical plug with a cord, comprising:
an enclosure portion including at least two members each defined by a top portion, side portions, and a base, said members moveable between an open position and a closed position;
an external cord tethering portion for detachably encircling the cord associated with said enclosure portion;
said enclosure portion is configured to taper on said side portions towards said cord tethering portion to substantially conform to the overall shape of the plug thereby allowing the enclosure to contain only the plug of a plug-socket connection;
a hinge mechanism connecting said members to each other; and
when in said closed position, said enclosure portion completely encloses said plug for preventing unwanted engagement of the plug with a socket and is configured to be openable without the use of tools.

19. The electrical plug protector of claim 18 wherein said hinge mechanism is located on said base of said plug protector.

20. The electrical plug protector of claim 18 wherein said hinge mechanism is located on one of said side portions of said plug protector.

21. An electrical plug protector for use on an electrical plug with a cord, comprising:
an enclosure portion with members moveable between an open position and a closed position;
said enclosure portion includes at least two members each defined by a top portion, side portions, and a base;
an external cord tethering portion for detachably encircling the cord associated with said enclosure portion;
said enclosure portion is configured to taper on said side portions towards said cord tethering portion to substantially conform to the overall shape of the plug thereby allowing the enclosure to contain only the plug of a plug-socket connection;
said enclosure portion substantially restricts axial, lateral and horizontal movement of said cord and plug;
a clasp located at said tethering portion for detachably encircling the cord, thereby allowing the enclosure portion to move slideably along the cord when said clasp is in a locked position and the enclosure portion is in the open position; and
when in said closed position, said enclosure portion completely encloses said plug for preventing unwanted engagement of the plug with a socket and is configured to be openable without the use of tools.
